(19) United States
(12) Patent Application Publication
(10) Pub. No.: US 2021/0356369 A1
(43) Pub. Date: Nov. 18, 2021

(54) HIGH THROUGHPUT STATISTICAL CHARACTERIZATION METHOD OF METAL MICROMECHANICAL PROPERTIES

(71) Applicant: NCS Testing Technology CO.,LTD, Beijing (CN)

(72) Inventors: Haizhou WANG, Beijing (CN); Qun REN, Beijing (CN); Lei ZHAO, Beijing (CN); Xuejing SHEN, Beijing (CN); Hui WANG, Beijing (CN); Dongling LI, Beijing (CN); Weihao WAN, Beijing (CN); Wenyu ZHANG, Beijing (CN); Xing YU, Beijing (CN); Lixia YANG, Beijing (CN)

(73) Assignee: NCS Testing Technology CO.,LTD

(21) Appl. No.: 17/391,017

(22) Filed: Aug. 1, 2021

(30) Foreign Application Priority Data
Aug. 27, 2020 (CN) 202010879316.8

(51) Int. Cl. G01N 3/12

(52) U.S. Cl. CPC G01N 3/12; G01N 2203/0019; G01N 2203/0042; G01N 2203/0232; G01N 2203/0641; G01N 2203/006

(57) ABSTRACT

The present invention discloses a high throughput statistical characterization method of metal micromechanical properties, which comprises: grinding and polishing a metal sample until specular reflection finish satisfies a test requirement; marking position coordinates of a to-be-measured area on the metal sample by a microhardness tester to ensure the comparison of the same to-be-measured area; conducting an isostatic pressing strain test on the to-be-measured area by an isostatic pressing technology; and comparing high throughput characterization of components, microstructures, microdefects and three-dimensional surface morphology of the metal sample before and after isostatic pressing strain to obtain the full-view-field cross-scale high throughput statistical characterization of micromechanical property uniformity of the metal sample.

### TECHNICAL FIELD

The present invention relates to the technical field of high throughput characterization of metal material, and particularly relates to a high throughput statistical characterization method of metal micromechanical properties.

### BACKGROUND

Metal material is key component material for supporting important fields of national defense construction, aerospace, nuclear industry, infrastructure, etc. The failure behavior of the metal material brings huge hidden danger to the service safety, and also brings other potential hazards that are difficult to estimate. For example, the presence of microcracks, inclusions, micropores and other types of defects of the material may result in weak micromechanical properties and nonuniform distribution in the local area of the metal material. In the actual service process, the area with weak material micromechanical properties may first have crack initiation and propagation, and then may lead to failure behaviors such as material fracture. Therefore, in order to ensure the service safety of the material and screen all areas with weak micromechanical properties to the maximum extent, the micromechanical properties of the sample need to be subjected to full-view-field cross-scale high throughput characterization to find the areas with weak mechanical properties which may cause the failure behavior of the material, to provide accurate quantitative data for the design and safe service of the metal material. At present, the mechanical test and characterization technologies of the material mainly include macromechanical and micromechanical tests, wherein the macromechanical tests include tests such as sample stretching, compression, bending, torsion, shear, impact and fatigue, and the micromechanical tests include tests such as instrumented indentation, microcantilever beam bending, micro tension and micropillar compression. At present, the developed micromechanical test technology is based on the principle of discontinuous testing. By taking the microindentation method to test the hardness of the material as an example, the test resolution mainly depends on the size of an indenter, so it is difficult to reflect the mechanical properties of all microareas of the material.

The isostatic pressing technology is widely used for material forming and densification, which uses fluid as a pressure transmitting medium. A “fluid indenter” can continuously and uniformly apply the load equivalently to all areas of the sample surface. Due to the nonuniform intrinsic characteristic of the material, the components, microstructures and defect features of different microareas of the material have some differences. Therefore, the micromechanical properties of different positions also show significant differences. By changing test parameters of isostatic pressing pressure and holding time, different types of microstructures or microdefects on the surface of the material will generate strain of different degrees and features. For defect positions, such as inclusions, holes and microcracks, of areas with weak material mechanical properties, more severe strain may be generated under the same load, and deformation or fracture may occur. For example, strain such as fracture or depressed deformation after compression may occur near the material defects. The three-dimensional surface morphology of the material is scanned, processed and analyzed by a white light interference three-dimensional profilometer to obtain statistical analysis of different degrees of strain on the sample surface. By combining the characterization of components and microstructures/microdefects of the microareas of the sample, the full-view-field cross-scale high throughput screening and characterization of micromechanical properties of the metal sample can be obtained. However, at present, there is no method for obtaining the full-view-field cross-scale high throughput screening and characterization of micromechanical properties of the metal material with combination of the characterization of the components, microstructures, microdefects and three-dimensional surface morphology based on the isostatic pressing principle.

### SUMMARY

The purpose of the present invention is to provide a high throughput statistical characterization method of metal micromechanical properties, which combines the characterization of sample components, microstructures, microdefects and three-dimensional surface morphology, provides a new method for the screening and characterization of areas with weak material mechanical properties, provides accurate quantitative data for material quality evaluation and service safety assessment, and provides theoretical guidance for design and preparation of material strengthening and toughening.

To achieve the above purpose, the present invention provides the following technical solution:

A high throughput statistical characterization method of metal micromechanical properties comprises the following steps:

S1, grinding and polishing a metal sample until specular reflection finish satisfies a test requirement;

S2, marking position coordinates of a to-be-measured area on the metal sample by a microhardness tester or a nanoindentor;

S3, obtaining the characterization of components, microstructures, microdefects and three-dimensional surface morphology of the metal sample before isostatic pressing strain of the to-be-measured area based on the position coordinates of the to-be-measured area;

S4, conducting an isostatic pressing strain test on the surface of the sample by an isostatic pressing technology to obtain characterization of the components, microstructures, microdefects and three-dimensional surface morphology of the metal sample after isostatic pressing strain;

S5, comparing the characterization of the components, microstructures, microdefects and three-dimensional surface morphology of the metal sample before and after isostatic pressing strain to obtain the full-view-field cross-scale high throughput statistical characterization of micromechanical properties of the metal sample.

Optionally, the step S1 of grinding and polishing the metal sample until specular reflection finish satisfies the test requirement specifically comprises:

Grinding and polishing the metal sample to obtain the specular reflection finish, and satisfying the test requirement of the sample if no obvious scratch is observed under an optical microscope.

Optionally, the step S2 of marking position coordinates of the to-be-measured area on the metal sample by the microhardness tester/the nanoindentor specifically comprises:

Marking different positions of the to-be-measured area on the metal sample by the nanoindentor, wherein the size of the to-be-measured area is 1-30 mm×1-30 mm, which provides coordinate information for the establishment of the statistical relationship characterization of the components, microstructures, microdefects and three-dimensional surface morphology on the same area.

Optionally, the step S3 of obtaining the characterization of the components, microstructures, microdefects and three-dimensional surface morphology of the metal sample before isostatic pressing strain of the to-be-measured area specifically comprises:

Analyzing component distribution of the metal sample by combining microbeam X-ray fluorescence analysis and energy spectrum analysis before isostatic pressing strain; analyzing and characterizing the microstructures and the microdefects of the metal sample by combining an automatic optical microscope, a high throughput scanning electron microscope, a conventional scanning electron microscope and an energy spectrum analyzer; analyzing and characterizing the three-dimensional surface morphology of the metal sample by a white light interference three-dimensional profilometer.

Optionally, the step S4 of conducting an isostatic pressing strain test on the surface of the sample by the isostatic pressing technology to obtain the characterization of the components, microstructures, microdefects and three-dimensional surface morphology of the metal sample after isostatic pressing strain specifically comprises:

Setting the pressure of the isostatic pressing test as 10-300 MPa and holding time as 10-300 min; transferring intensity of pressure equally in all directions through fluid and continuously acting uniformly on the to-be-measured area to obtain the surface microstrain of the to-be-measured area; completing the isostatic pressing strain test of the sample;

Analyzing component distribution of the metal sample by combining microbeam X-ray fluorescence analysis and energy spectrum analysis after isostatic pressing strain; analyzing and characterizing the microstructures and the microdefects of the metal sample by combining an automatic optical microscope, a high throughput scanning electron microscope, a conventional scanning electron microscope and an energy spectrum analyzer; analyzing and characterizing the three-dimensional surface morphology of the metal sample by a white light interference three-dimensional profilometer.

Optionally, the step S5 of comparing the characterization of the components, microstructures, microdefects and three-dimensional surface morphology of the metal sample before and after isostatic pressing strain to obtain the full-view-field cross-scale high throughput statistical characterization of micromechanical properties of the metal sample specifically comprises:

Comparing the three-dimensional surface morphology of the metal sample before and after isostatic pressing strain to obtain the statistical distribution of the original height and the relative height of the metal sample surface;

Realizing high throughput screening of the areas with weak material micromechanical properties by combining the features of the components and microstructures/microdefects of the metal sample surface on the to-be-measured area before and after isostatic pressing strain;

Establishing the full-view-field cross-scale high throughput statistical characterization of uniformity of the micromechanical properties of the metal sample surface.

Optionally, the metal sample is pure metal single crystal, pure metal polycrystal, single crystal alloy, polycrystalline alloy, amorphous alloy or powder alloy.

According to the specific embodiments provided by the present invention, the present invention discloses the following technical effects: compared with the prior art, the high throughput statistical characterization method of metal micromechanical properties provided by the present invention has the following beneficial effects:

Firstly, traditional testing technologies of micromechanical properties, such as instrumented indentation method and micro tension/compression, can accurately test the micromechanical properties. However, based on the discontinuous testing principle, it is impossible to characterize the micromechanical properties of all areas of the sample. By using the isostatic pressing principle, the surface microstrain of all the areas on the sample surface can be obtained by the present invention through one isostatic pressing strain test.

Secondly, the fluid medium is used to continuously and uniformly apply the load equivalently to all surface areas of the metal material to realize microstrain of the material surface, and point-to-point comparison screening of surface microstrain of the sample can be realized by combining the characterization of the components, microstructures, microdefects and three-dimensional surface morphology of the sample.

Thirdly, high throughput screening of various defects such as holes, microcracks and inclusions in areas with weak micromechanical properties of metal material is realized; and full-view-field cross-scale high throughput statistical characterization of uniformity of the micromechanical properties of large-size centimeter-level metal material is realized.

Fourthly, high throughput characterization of uniformity of the micromechanical properties of various metal materials such as pure metal single crystal, pure metal polycrystal, single crystal alloy, polycrystalline alloy, amorphous alloy and powder alloy can be realized.

### DESCRIPTION OF THE DRAWINGS

To more clearly describe the technical solutions in the embodiments of the present invention or in prior art, the drawings required to be used in the embodiments will be simply presented below. Apparently, the drawings in the following description are merely some embodiments of the present invention, and for those skilled in the art, other drawings can also be obtained according to these drawings without contributing creative labor.

FIG. 1 shows measurement results of white light interference three-dimensional morphology of surface three-dimensional morphology before isostatic pressing strain of a sample in embodiment 1 of the present invention;

FIG. 2 is a metallographic picture of a sample surface after isostatic pressing in embodiment 1 of the present invention;

FIG. 3 shows measurement results of white light interference three-dimensional morphology of surface three-dimensional morphology after isostatic pressing strain of a sample in embodiment 1 of the present invention;

FIG. 4 shows statistical distribution of relative height in a range of −20 μm to −18 nm after three-dimensional morphological filtering on the surface of a sample to-be-measured area (a circular area with a diameter of ϕ8 is intercepted with the sample center as the center of the circle) before isostatic pressing strain in embodiment 1 of the present invention;

FIG. 5 shows statistical distribution of relative height in a range of −20 μm to −18 nm after three-dimensional morphological filtering on the surface of a sample to-be-measured area (a circular area with a diameter of ϕ8 and with the center as the center of the circle) after isostatic pressing strain in embodiment 1 of the present invention;

FIG. 6 shows relative height comparison after three-dimensional morphological filtering on the sample surface before and after isostatic pressing strain of a sample in embodiment 1 of the present invention;

FIG. 7 is a contour map of a severe strain area on a surface of a sample after contour filtering in embodiment 1;

FIG. 8 shows scanning electron microscope observation results near a severe strain area after isostatic pressing strain of a sample in embodiment 1;

FIG. 9 shows tongue patterns generated by surface tear corresponding to a severe strain area after isostatic pressing strain of a sample in embodiment 1; and

FIG. 10 shows surface strain pits corresponding to a severe strain area after isostatic pressing strain of a sample in embodiment 1.

In the figures, reference signs are as follows:

1. a severe strain area after sample filtering after isostatic pressing strain.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The purpose of the present invention is to provide a high throughput statistical characterization method of metal micromechanical properties, which combines the characterization of sample components, microstructures, microdefects and three-dimensional surface morphology, provides a new method for the screening and characterization of areas with weak material mechanical properties, provides accurate quantitative data for material quality evaluation and service safety assessment, and provides theoretical guidance for design and preparation of material strengthening and toughening.

To make the above-mentioned purpose, features and advantages of the present invention more clear and understandable, the present invention will be further described below in detail in combination with the drawings and specific embodiments.

The high throughput statistical characterization method of metal micromechanical properties provided by the present invention comprises the following steps:

S1, grinding and polishing a metal sample until specular reflection finish satisfies a test requirement;

S2, marking position coordinates of a to-be-measured area on the metal sample by a microhardness tester or a nanoindentor;

S3, obtaining the characterization of components, microstructures, microdefects and three-dimensional surface morphology of the metal sample before isostatic pressing strain of the to-be-measured area based on the position coordinates of the to-be-measured area;

S4, conducting an isostatic pressing strain test on a to-be-measured sample by an isostatic pressing technology to obtain characterization of the components, microstructures, microdefects and three-dimensional surface morphology of the metal sample after isostatic pressing strain;

S5, comparing the characterization of the components, microstructures, microdefects and three-dimensional surface morphology of the metal sample before and after isostatic pressing strain to obtain the full-view-field cross-scale high throughput statistical characterization of micromechanical properties of the metal sample.

In embodiment 1, based on the isostatic pressing principle, the pressure transmitting medium is used to uniformly apply the pressure equivalently to the surface of ultra-supercritical G115 heat resistant steel to generate strain, and on this basis, by combining the characterization of the components, microstructures, microdefects and three-dimensional surface morphology of the sample surface, a new screening method for the micromechanical properties for full-view-field cross-scale high throughput statistical characterization of the micromechanical properties of the ultra-supercritical G115 heat resistant steel is established. The specific implementation process comprises the following steps:

step 1, cutting, metallographically grinding and polishing the sample; and satisfying basic requirements of various analysis tests for the sample in the present invention when the sample surface achieves a specular reflection effect and no obvious scratch is observed under an optical microscope;

step 2, marking coordinate positions of a to-be-measured area on a G115 heat resistant steel sample by a micro vickers indenter;

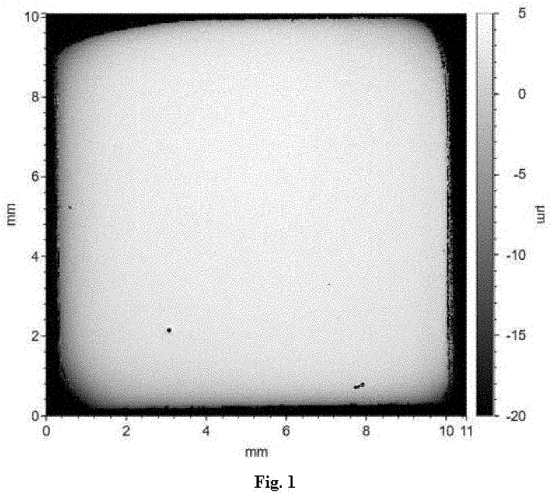

step 3, obtaining component distribution of the surface of the G115 heat resistant steel sample by combining microbeam X-ray fluorescence analysis and energy spectrum analysis through the characterization of sample components, microstructures, microdefects and three-dimensional surface morphology before isostatic pressing; realizing analysis and characterization of the microstructures and the microdefects of the sample surface by combining an automatic optical microscope, a high throughput scanning electron microscope, a conventional scanning electron microscope and an energy spectrum analyzer; analyzing and characterizing the three-dimensional surface morphology of the sample by a white light interference three-dimensional profilometer; FIG. 1 shows the three-dimensional surface morphology of the ultra-supercritical G115 heat resistant steel before isostatic pressing strain; it can be seen that, the surface of the sample is smooth and there is little sharp change in height;

step 4, in an isostatic pressing strain experiment, setting the pressure of the isostatic pressing as 190 MPa and holding time as 30 min; and making all surface areas of the sample under uniform action of the same load produce surface microstrain;

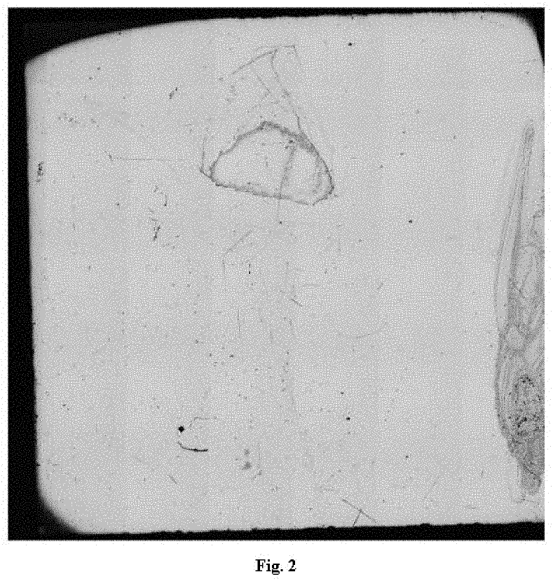

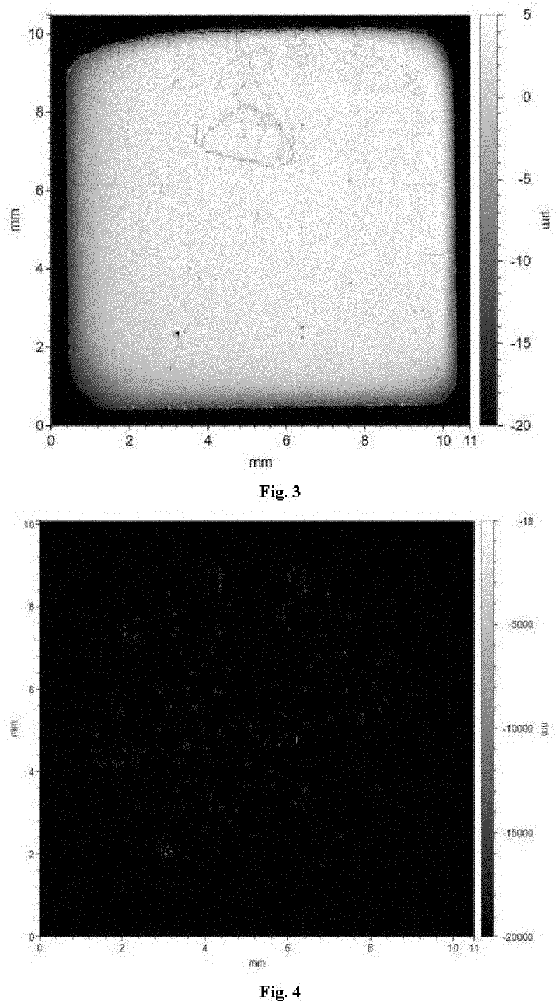

step 5, characterizing sample components, microstructures, microdefects and three-dimensional surface morphology after isostatic pressing strain; obtaining component distribution of the surface of the sample by combining microbeam X-ray fluorescence analysis and energy spectrum analysis; realizing analysis and characterization of the microstructures and the microdefects of the sample surface by combining an automatic optical microscope, a high throughput scanning electron microscope, a conventional scanning electron microscope and an energy spectrum analyzer; analyzing and characterizing the three-dimensional surface morphology of the sample by an optical profilometer such as a white light interference three-dimensional profilometer; FIG. 2 shows the surface morphology of the sample under the optical microscope after isostatic pressing strain; it can be seen that the microscopic uniformity of the sample become worse, and many areas have significant differences from a matrix; FIG. 3 shows the three-dimensional morphology of the sample surface after isostatic pressing strain, and it can be seen that a large number of microareas on the sample surface have severe strain; comparing with the results of the automatic optical microscope, the high throughput scanning electron microscope, the conventional scanning electron microscope and the energy spectrum analyzer, wherein the results indicate that a large number of severe strains appear on the sample surface after isostatic pressing strain, which indicates that the areas of the sample are firstly plastically deformed or fractured under the same load, which are areas with weak micromechanical properties, such as micropores, microcracks, inclusions and other defects;

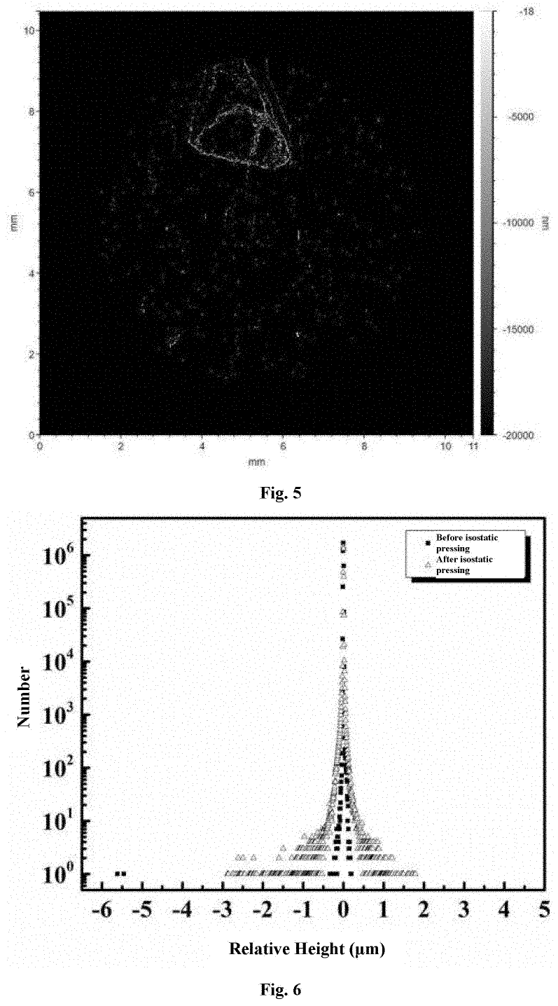

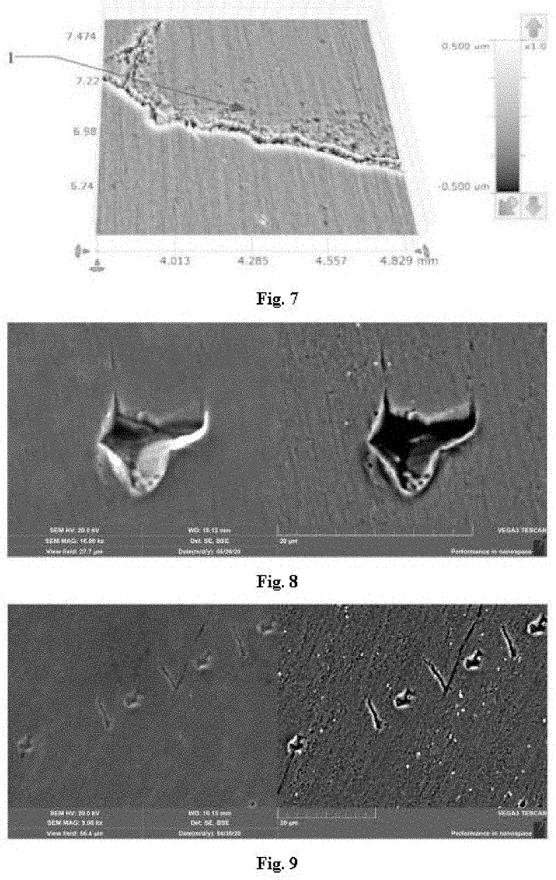

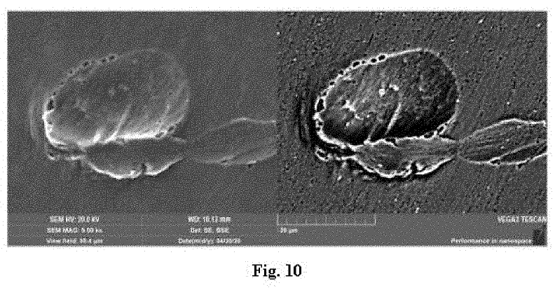

step 6, processing and analyzing experimental data; conducting filtering and statistical analysis on the three-dimensional morphology data of the sample surface before and after the isostatic pressing strain to obtain the statistical distribution of the area with severe sample deformation, i.e., with weak mechanical properties, as shown in FIG. 4 and FIG. 5. FIG. 6 shows the relative height comparison of the sample surface after three-dimensional morphology filtering before and after isostatic pressing strain. The results indicate that after isostatic pressing, many areas of the sample surface have severe surface strain, which indicates that these areas may be plastically deformed or fractured. As shown in FIG. 7, the area indicated by the arrow is one of the many areas which have severe deformation after isostatic pressing, and the amount of deformation is about 100 nm. Label 1 in the figure is a severe strain area after sample filtering after isostatic pressing strain. FIG. 8 shows the SEM results corresponding to the severe strain area in FIG. 7. In combination with EDS analysis, the results show that the surface strain in this area corresponds to the tear of inclusions, which indicates that the bonding strength between the inclusions and the matrix is weak, and the area is torn firstly under the action of load. As shown in FIG. 9 and FIG. 10, the area with relatively severe change on the sample represents that the area with weak mechanical properties also corresponds to various other types of strain modes, and multiple action mechanisms leading to weak mechanical properties of the sample can be analyzed in detail according to the strain types and the deformation law.

In embodiment 2, based on the isostatic pressing principle, the pressure transmitting medium is used to uniformly apply the pressure equivalently to the surface of Ni-based single crystal superalloy to generate strain, and on this basis, by combining the characterization of the components, microstructures, microdefects and three-dimensional surface morphology, a new screening method for the micromechanical properties for full-view-field cross-scale high throughput statistical characterization of the micromechanical properties of the Ni-based single crystal superalloy is established. The specific implementation process comprises the following steps:

Step 1, cutting, metallographically grinding and polishing the sample; and satisfying basic requirements of various analysis tests for the sample in the present invention when the sample surface obtains a specular reflection effect and no obvious scratch is observed under an optical microscope;

Step 2, marking coordinates of a to-be-measured area on a Ni-based single crystal superalloy sample by a micro vickers indenter;

Step 3, obtaining component distribution of the surface of the sample by combining microbeam X-ray fluorescence analysis and energy spectrum analysis through the characterization of sample components, microstructures, microdefects and three-dimensional surface morphology before isostatic pressing; realizing analysis and characterization of the microstructures/the microdefects of the sample by combining an automatic optical microscope, a high throughput scanning electron microscope, a conventional scanning electron microscope and an energy spectrum analyzer; analyzing and characterizing the three-dimensional surface morphology of the sample by an optical profilometer such as a white light interference three-dimensional profilometer;

Step 4, in an isostatic pressing strain experiment, setting the pressure of the isostatic pressing as 190 MPa and holding time as 30 min; and making all surface areas of the sample under action of the same load produce surface microstrain;

Step 5, characterizing sample components, microstructures, microdefects and three-dimensional surface morphology after isostatic pressing strain; obtaining component distribution of the surface of the sample by combining microbeam X-ray fluorescence analysis and energy spectrum analysis; realizing analysis and characterization of the microstructures and the microdefects of the sample surface by combining an automatic optical microscope, a high throughput scanning electron microscope, a conventional scanning electron microscope and an energy spectrum analyzer; analyzing and characterizing the three-dimensional surface morphology of the sample by the white light interference three-dimensional profilometer;

Step 6, processing and analyzing experimental data; conducting data processing and statistical distribution analysis on the three-dimensional morphology data of the sample surface before and after the isostatic pressing strain to obtain the statistical distribution law of the area with severe sample deformation, i.e., with weak mechanical properties. The results indicate that many areas of the sample surface have severe surface strain after isostatic pressing. In combination with the information of the microstructures and the microdefects on the sample surface, the generation mechanism of various types of strain of the sample can be analyzed in detail.

Similarly, the method of the present invention is used for conducting high throughput statistical characterization of metal micromechanical properties in different metal materials.

In embodiment 3, based on the isostatic pressing principle, the pressure transmitting medium is used to uniformly apply the pressure equivalently to the surface of cast FGH96 superalloy to generate strain, and on this basis, by combining the high throughput characterization of the components, microstructures, microdefects and three-dimensional surface morphology, a new screening method for the micromechanical properties for full-view-field cross-scale high throughput statistical characterization of the micromechanical properties of the cast FGH96 superalloy is established.

In embodiment 4, based on the isostatic pressing principle, the pressure transmitting medium is used to uniformly apply the pressure equivalently to the surface of forged FGH96 superalloy to generate strain, and on this basis, by combining the characterization of the components, microstructures, microdefects and three-dimensional surface morphology, a new screening method for the micromechanical properties for full-view-field cross-scale high throughput statistical characterization of the micromechanical properties of the forged FGH96 superalloy is established.

In embodiment 5, based on the isostatic pressing principle, the pressure transmitting medium is used to uniformly apply the pressure equivalently to the surface of bridge steel material to generate strain, and on this basis, by combining the characterization of the components, microstructures, microdefects and three-dimensional surface morphology, a new screening method for the micromechanical properties for full-view-field cross-scale high throughput statistical characterization of the micromechanical properties of the bridge steel material is established.

In embodiment 6, based on the isostatic pressing principle, the pressure transmitting medium is used to uniformly apply the pressure equivalently to the surface of cast Ti-6Al-4V alloy to generate strain, and on this basis, by combining the characterization of the components, microstructures, microdefects and three-dimensional surface morphology, a new screening method for the micromechanical properties for full-view-field cross-scale high throughput statistical characterization of the micromechanical properties of the cast Ti-6Al-4V alloy is established.

In embodiment 7, based on the isostatic pressing principle, the pressure transmitting medium is used to uniformly apply the pressure equivalently to the surface of 3D printing Ti-6Al-4V alloy to generate strain, and on this basis, by combining the characterization of the components, microstructures, microdefects and three-dimensional surface morphology, a new screening method for the micromechanical properties for full-view-field cross-scale high throughput statistical characterization of the micromechanical properties of the 3D printing Ti-6Al-4V alloy is established.

In embodiment 8, based on the isostatic pressing principle, the pressure transmitting medium is used to uniformly apply the pressure equivalently to the surface of standard hardness block material to generate strain, and on this basis, by combining the characterization of the components, microstructures, microdefects and three-dimensional surface morphology, a new screening method for the micromechanical properties for full-view-field cross-scale high throughput statistical characterization of the micromechanical properties of the standard hardness block material is established.

In the high throughput statistical characterization method of metal micromechanical properties provided in the present invention, based on the isostatic pressing principle, the fluid medium is used to continuously and uniformly apply the load equivalently to all the surface areas of the metal material to realize microstrain of the material surface, and the characterization of the sample components, microstructures, microdefects and three-dimensional surface morphology is combined. The method is a new screening and characterization method for the mechanical properties for realizing full-view-field cross-scale high throughput statistical characterization of the micromechanical properties of the metal material. The main application fields of the present invention comprise the full-view-field cross-scale high throughput statistical characterization of the micromechanical properties of various metal materials such as pure metal single crystal, pure metal polycrystal, single crystal alloy, polycrystalline alloy, amorphous alloy and powder alloy.

Specific individual cases are applied herein for elaborating the principle and embodiments of the present invention. The illustration of the above embodiments is merely used for helping to understand the method and the core thought of the present invention. Meanwhile, for those ordinary skilled in the art, specific embodiments and the application scope may be changed in accordance with the thought of the present invention. In conclusion, the contents of the description shall not be interpreted as a limitation to the present invention.

1. A high throughput statistical characterization method of metal micromechanical properties, comprising the following steps:
S1, grinding and polishing a metal sample until specular reflection finish satisfies a test requirement;
S2, marking position coordinates of a to-be-measured area on the metal sample by a microhardness tester or a nanoindentor;
S3, obtaining the characterization of components, microstructures, microdefects and three-dimensional surface morphology of the metal sample before isostatic pressing strain of the to-be-measured area based on the position coordinates of the to-be-measured area;
S4, conducting an isostatic pressing strain test on the surface of the sample by an isostatic pressing technology, and characterizing the components, microstructures, microdefects and three-dimensional surface morphology of the metal sample after isostatic pressing strain;
S5, comparing the components, microstructures, microdefects and three-dimensional surface morphology of the metal sample before and after isostatic pressing strain to obtain the full-view-field cross-scale high throughput screening and statistical characterization of micromechanical properties of the metal sample.

2. The high throughput statistical characterization method of metal micromechanical properties according to claim 1, wherein the step S1 of grinding and polishing the metal sample until specular reflection finish satisfies the test requirement specifically comprises:
grinding and polishing the metal sample to obtain the specular reflection finish, and satisfying the test requirement of the sample if no obvious scratch is observed under an optical microscope.

3. The high throughput statistical characterization method of metal micromechanical properties according to claim 1, wherein the step S2 of marking position coordinates of the to-be-measured area on the metal sample by the microhardness tester or the nanoindentor specifically comprises:
marking the to-be-measured area on the metal sample by the nanoindentor, wherein the size of the to-be-measured area is 1-30 mm×1-30 mm, which provides coordinate information for the establishment of the statistical relationship characterization of the components, microstructures, microdefects and three-dimensional surface morphology on the same area.

4. The high throughput statistical characterization method of metal micromechanical properties according to claim 1, wherein the step S3 of obtaining the characterization of the components, microstructures, microdefects and three-dimensional surface morphology of the metal sample before isostatic pressing strain of the to-be-measured area specifically comprises:
analyzing component distribution of the metal sample by combining microbeam X-ray fluorescence analysis and energy spectrum analysis before isostatic pressing strain; analyzing and characterizing the microstructures and the microdefects of the metal sample by combining an automatic optical microscope, a high throughput scanning electron microscope, a conventional scanning electron microscope and an energy spectrum analyzer; analyzing and characterizing the three-dimensional surface morphology of the metal sample by a white light interference three-dimensional profilometer.

5. The high throughput statistical characterization method of metal micromechanical properties according to claim 1, wherein the step S4 of conducting an isostatic pressing strain test on the surface of the sample by the isostatic pressing technology to obtain the characterization of the components, microstructures, microdefects and three-dimensional surface morphology of the metal sample after isostatic pressing strain specifically comprises:
setting the pressure of the isostatic pressing test as 10-300 MPa and holding time as 10-300 min; transferring intensity of pressure equally in all directions through fluid and continuously acting uniformly on the to-be-measured area to obtain the surface microstrain of the to-be-measured area; completing the isostatic pressing strain test of the sample;
analyzing component distribution of the metal sample by combining microbeam X-ray fluorescence analysis and energy spectrum analysis after isostatic pressing strain; analyzing and characterizing the microstructures and the microdefects of the metal sample by combining an automatic optical microscope, a high throughput scanning electron microscope, a conventional scanning electron microscope and an energy spectrum analyzer; analyzing and characterizing the three-dimensional surface morphology of the metal sample by a white light interference three-dimensional profilometer.

6. The high throughput statistical characterization method of metal micromechanical properties according to claim 1, wherein the step S5 of comparing the characterization of the components, microstructures, microdefects and three-dimensional surface morphology of the metal sample before and after isostatic pressing strain to obtain the full-view-field cross-scale high throughput statistical characterization of micromechanical properties of the metal sample specifically comprises:
comparing the three-dimensional surface morphology of the metal sample before and after isostatic pressing strain to obtain the statistical distribution of the original height and the relative height of the metal sample surface;
realizing high throughput screening of the areas with weak material micromechanical properties by combining the features of the components and microstructures/microdefects of the metal sample surface on the to-be-measured area before and after isostatic pressing strain;
establishing the full-view-field cross-scale high throughput statistical characterization of micromechanical properties of the metal sample surface.

7. The high throughput statistical characterization method of metal micromechanical properties according to claim 1, wherein the metal sample is pure metal single crystal, pure metal polycrystal, single crystal alloy, polycrystalline alloy, amorphous alloy or powder alloy.
